(19) United States
(12) Patent Application Publication
(10) Pub. No.: US 2024/0394298 A1
(43) Pub. Date: Nov. 28, 2024

(54) GENERALIZED TRAVERSAL FRAMEWORK FOR GEOMETRIC QUERY PROCESSING

(71) Applicant: NVIDIA CORPORATION, Santa Clara, CA (US)

(72) Inventors: Saumyadip MUKHOPADHYAY, Beaverton, OR (US); Vishal MEHTA, San Jose, CA (US); Maximilian Anton RIETMANN, Zurich (CH); John Arthur SWANSON, Forest Grove, OR (US); Ingo WALD, Salt Lake City, UT (US); Vivek Kumar SINGH, Portland, OR (US)

(21) Appl. No.: 18/324,025

(22) Filed: May 25, 2023

(51) Int. Cl. G06F 16/532; G06F 16/22

(52) U.S. Cl. CPC G06F 16/532; G06F 16/2246

(57) ABSTRACT

One embodiment of the present invention sets forth a technique for processing a geometric query. The technique includes determining a tree structure and a set of configurable parameters specified in the geometric query, wherein the set of configurable parameters includes one or more query primitives and one or more search routines. The technique also includes performing one or more operations that traverse the tree structure and execute the one or more search routines to match the one or more query primitives to a first set of geometric objects included in the tree structure. The technique further includes generating a response to the geometric query, wherein the response includes the first set of geometric objects.

### BACKGROUND

### Field of the Various Embodiments

Embodiments of the present disclosure relate generally to computer science and hierarchical data structures and, more specifically, to a generalized traversal framework for geometric query processing.

### DESCRIPTION OF THE RELATED ART

Photolithography, or optical lithography, is a process used in the fabrication of integrated circuits (ICs), microelectromechanical systems (MEMS), and other micro- and nano-scale semiconductor devices. Photolithography involves the transfer of a geometric pattern from an optical mask onto a thin layer of photosensitive material (called a photoresist) coated on a substrate such as a silicon wafer. When the photoresist is exposed to ultraviolet (UV) light through the mask, the geometric pattern is transferred onto the substrate. Regions of the substrate that are not protected by photoresist can then be removed using an etching process to form various features in the substrate.

However, as modern semiconductor devices increasingly incorporate smaller and more densely packed features, traditional photolithography techniques are unable to accurately produce those features. More specifically, the ability to project a clear image of a feature from a geometric pattern onto a silicon wafer can be physically limited by the wavelength of the light used to perform the projection, the numerical aperture of the lens used in the projection, the depth of focus associated with the projection, scattering or blurring of light caused by neighboring features, and/or other factors. These physical limits are approached or exceeded as features continue to shrink in size and increase in density within semiconductor devices, which can result in blurring, underexposure, optical aberrations, and/or other types of distortions that can negatively impact fabrication complexity, overall yield, or ultimate semiconductor device performance.

To overcome the above challenges, computational lithography techniques have been developed to improve the accuracy and precision of pattern transfer during photolithography. For example, computational lithography techniques could be used to modify an optical mask in a way that compensates for limitations in the optical resolution of projection system, diffraction-related blurring and underexposure, and/or individual characteristics of the lens system and photolithography process.

Computational lithography approaches typically involve iteratively optimizing billions of polygons in a mask pattern to improve the lithographic printability of the corresponding shapes. During iterative optimization, polygons are stored in a hierarchical data structure that gradually partitions the layout of the mask pattern into increasingly smaller regions and/or clusters of shapes. The hierarchical data structure is traversed during a geometric query that searches for and retrieves shapes that are intersected by, adjacent to, and/or within a certain distance of a query primitive such as a point, ray, polygon, and/or another type of geometric object. The retrieved shapes can then be optimized, analyzed using a simulation and/or model, and/or verified to meet design rules and guidelines for the corresponding photolithography process.

One drawback of conventional computational lithography techniques is that the geometric queries of hierarchical data structures in which mask geometries are stored are typically implemented in an inefficient and resource-intensive manner. Conventional geometric queries can involve different types and/or combinations of query primitives, distance or measures, traversals, hierarchical data structures, matching criteria, and/or other parameters that reflect the underlying optimization. Accordingly, when a particular type of geometric query is implemented within a conventional computational lithography technique, a separate workflow has to be programmed and executed to effect that particular type of geometric query. Additionally, geometric objects retrieved by conventional geometric queries typically are stored in memory and returned to a requesting component. The requesting component then filters the in-memory geometric objects before performing additional optimizations on the geometric objects. Because many of the returned geometric objects are filtered and not subsequently used by the requesting component, memory and processor resources oftentimes are unnecessarily consumed when executing geometric queries and/or using the results of geometric queries.

As the foregoing illustrates, what is needed in the art are more effective techniques for processing geometric queries of hierarchical data structures.

### SUMMARY

One embodiment of the present invention sets forth a technique for processing a geometric query. The technique includes determining a tree structure and a set of configurable parameters specified in the geometric query, wherein the set of configurable parameters includes one or more query primitives and one or more search routines. The technique also includes performing one or more operations that traverse the tree structure and execute the one or more search routines to match the one or more query primitives to a first set of geometric objects included in the tree structure. The technique further includes generating a response to the geometric query, wherein the response includes the first set of geometric objects.

One technical advantage of the disclosed techniques relative to the prior art is that, with the disclosed techniques, geometric queries involving traversal of hierarchical data structures can be defined and executed in a flexible, configurable manner. Accordingly, the disclosed techniques can be used to create and process geometric queries more quickly and efficiently than conventional approaches that involve programming and executing separate workflows for different types of geometric queries. Another technical advantage of the disclosed techniques is the ability to filter certain nodes and/or geometric objects in a hierarchical data structure before performing computationally intensive matching operations using the nodes and/or geometric objects. Consequently, the disclosed techniques can be used to process geometric queries with less latency and resource overhead than prior art approaches. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of the various embodiments.

FIG. 2 is a block diagram of a parallel processing unit (PPU) included in the parallel processing subsystem of FIG. 1, according to various embodiments.

FIG. 3 is a more detailed illustration of the traversal engine of FIG. 1, according to various embodiments.

FIG. 4 illustrates an exemplar table of configurable parameters for geometric queries that can be processed by the traversal engine of FIG. 1, according to various embodiments.

FIG. 5 sets forth a flow diagram of method steps for processing a geometric query, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### General Overview

Computational lithography techniques typically involve iteratively optimizing billions of polygons in mask patterns to improve the lithographic printability of the corresponding shapes. During this iterative optimization, polygons in a mask pattern are stored in a hierarchical data structure that gradually partitions the layout of the mask pattern into increasingly smaller regions or clusters of shapes. The hierarchical data structure is traversed during a geometric query that searches for and retrieves shapes that are intersected by, adjacent to, and/or within a certain distance of a query primitive such as a point, ray, polygon, and/or another type of geometric object. The retrieved shapes can then be optimized, analyzed using a simulation and/or model, and/or verified to meet design rules and guidelines for the corresponding photolithography process.

However, conventional geometric queries of hierarchical data structures in which mask geometries are stored are typically implemented in an inefficient and resource-intensive manner. These geometric queries can involve different types and/or combinations of query primitives, distance or measures, traversals, hierarchical data structures, matching criteria, and/or other parameters that reflect the underlying optimization. When a certain type of geometric query is used within a computational lithography technique, a separate workflow has to be programmed and executed to implement that type of geometric query. Additionally, geometric objects retrieved by a conventional geometric query are typically stored in memory and returned to a requesting component, which filters the in-memory geometric objects before performing additional optimization of the geometric objects. Because many of the returned geometric objects are not subsequently used by the requesting component, memory and processor resources are unnecessarily consumed in executing the geometric query and/or using the results of the geometric query.

To improve the flexibility and efficiency with which geometric queries of hierarchical data structures are implemented and executed, the disclosed techniques provide a generalized traversal framework for processing the geometric queries. The generalized traversal framework receives a given geometric query that specifies a hierarchical data structure to traverse, such as a bounding volume hierarchy (BVH) and/or another type of tree structure. The geometric query also includes a set of configurable parameters that control the traversal of the tree structure and/or processing of the geometric query. The configurable parameters also include (but are not limited to) data structures representing query primitives such as points, rays, line segments, boxes, and/or polygons; search routines that define or implement search criteria for matching the query primitives to geometric objects stored in the tree structure; sorting parameters used to sort shapes or regions that match the geometric query; and/or filter parameters used in filtering the shapes or regions during traversal of the hierarchical data structure.

The generalized traversal framework processes the geometric query by traversing the hierarchical data structure. During the traversal, the generalized traversal framework uses the search routines to determine whether or not a given node in the hierarchical data structure represents a region that intersects, overlaps with, is within a certain distance of, and/or otherwise meets the search criteria associated with one or more query primitives in the geometric query. The generalized traversal framework repeats the process with child nodes of any node that meets the search criteria. The generalized traversal framework also uses the filter parameters in the geometric query to filter nodes and/or the corresponding subtrees during the traversal. Once the traversal reaches a leaf node that meets the search criteria, the generalized traversal framework iterates over geometric objects stored in the leaf node and determines whether each geometric object meets the search criteria and/or passes any filters specified in the filter parameters. The generalized traversal framework then returns a set of geometric objects that both meet the search criteria and pass the filters in a response to the geometric query.

### System Overview

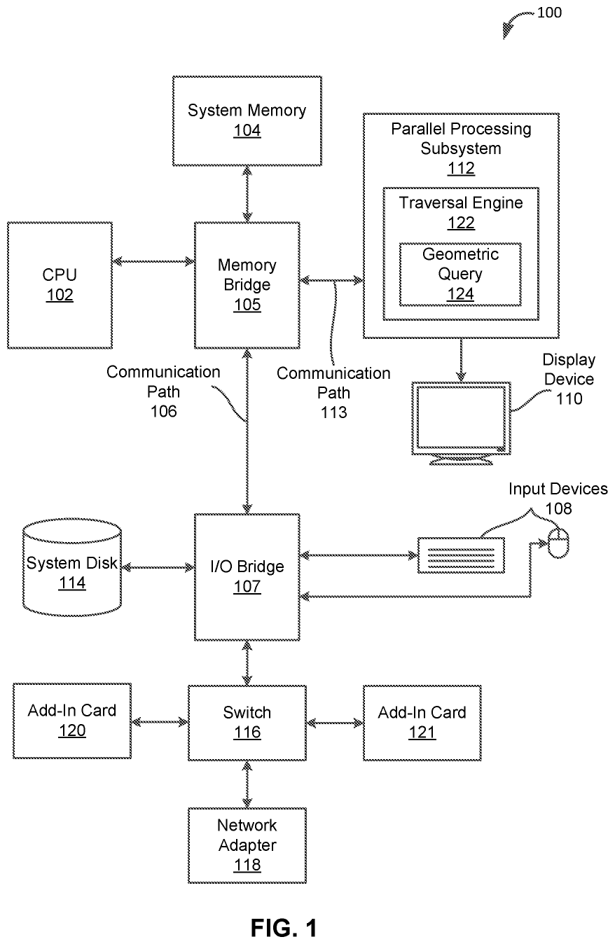

FIG. 1 is a block diagram illustrating a computer system 100 configured to implement one or more aspects of various embodiments. In some embodiments, computer system 100 is a machine or processing node operating in a data center, cluster, or cloud computing environment that provides scalable computing resources (optionally as a service) over a network.

In various embodiments, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via the network adapter 118. In one embodiment, switch 116 is configured to provide connections between I/O bridge 107 and other components of the computer system 100, such as a network adapter 118 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

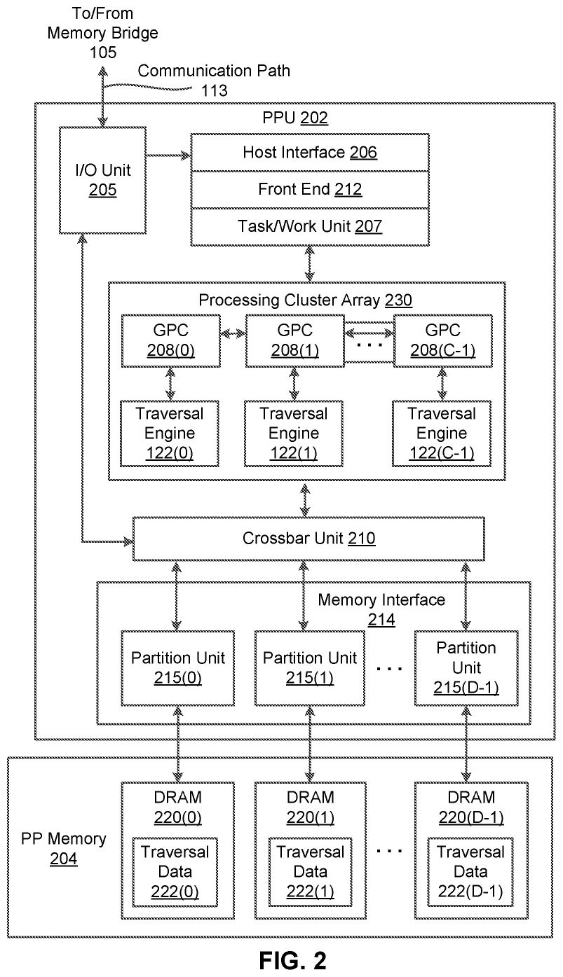

In some embodiments, parallel processing subsystem 112 includes a graphics subsystem that delivers pixels to an optional display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in conjunction with FIG. 2, such circuitry may be incorporated across one or more parallel processing units (PPUs), also referred to herein as parallel processors, included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver configured to manage the processing operations of the one or more PPUs within parallel processing subsystem 112.

In one or more embodiments, parallel processing subsystem 112 includes a traversal engine 122 that processes a geometric query 124 associated with a set of geometric objects. For example, the geometric objects could include shapes in a photolithography mask, physics simulation, computer game, two-dimensional (2D) or three-dimensional (3D) scene, and/or another type of spatial environment. Within this spatial environment, traversal engine 122 could be used to process a given geometric query 124 for the purposes of performing collision detection, proximity detection, ray tracing, nearest neighbor search, occlusion culling, visibility culling, and/or other tasks associated with the geometric objects.

In various embodiments, parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other embodiments, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to various embodiments. Although FIG. 2 depicts one PPU 202, as indicated above, parallel processing subsystem 112 can include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 includes a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to an optional display device 110 for display. In some embodiments, PPU 202 also may be configured for general-purpose processing and compute operations. In some embodiments, computer system 100 may be a server machine in a cloud computing environment. In such embodiments, computer system 100 may not have a display device 110. Instead, computer system 100 may generate equivalent output information by transmitting commands in the form of messages over a network via the network adapter 118.

As mentioned above, CPU 102 can operate as a master processor that controls and coordinates operations of other system components in computer system 100. In one embodiment, CPU 102 issues commands that control the operation of PPU 202. For example, CPU 102 could write a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a command queue, also referred to herein as a pushbuffer, to initiate processing of the stream of commands in the data structure. In one embodiment, the PPU 202 reads command streams from the command queue and then executes commands asynchronously relative to the operation of CPU 102. In embodiments where multiple pushbuffers are generated, execution priorities may be specified for each pushbuffer by an application program via device driver to control scheduling of the different pushbuffers.

In one embodiment, PPU 202 includes an I/O (input/output) unit 205 that communicates with the rest of computer system 100 via the communication path 113 and memory bridge 105. In one embodiment, I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In one embodiment, host interface 206 reads each command queue and transmits the command stream stored in the command queue to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In one embodiment, front end 212 transmits processing tasks received from host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by front end 212 from the host interface 206. Processing tasks that may be encoded as TMDs include indices associated with the data to be processed as well as state parameters and commands that define how the data is to be processed. For example, the state parameters and commands could define the program to be executed on the data. Also for example, the TMD could specify the number and configuration of the set of CTAs. Generally, each TMD corresponds to one task. The task/work unit 207 receives tasks from the front end 212 and ensures that general processing clusters GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, PPU 202 implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D partition units 215, where D≥1. Each partition unit 215 is coupled to one or more dynamic random access memories (DRAMs) 220 residing within PP memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

In one embodiment, a given GPC 208 may process data to be written to any of the DRAMs 220 within PP memory 204. In one embodiment, crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In some embodiments, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

In one embodiment, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

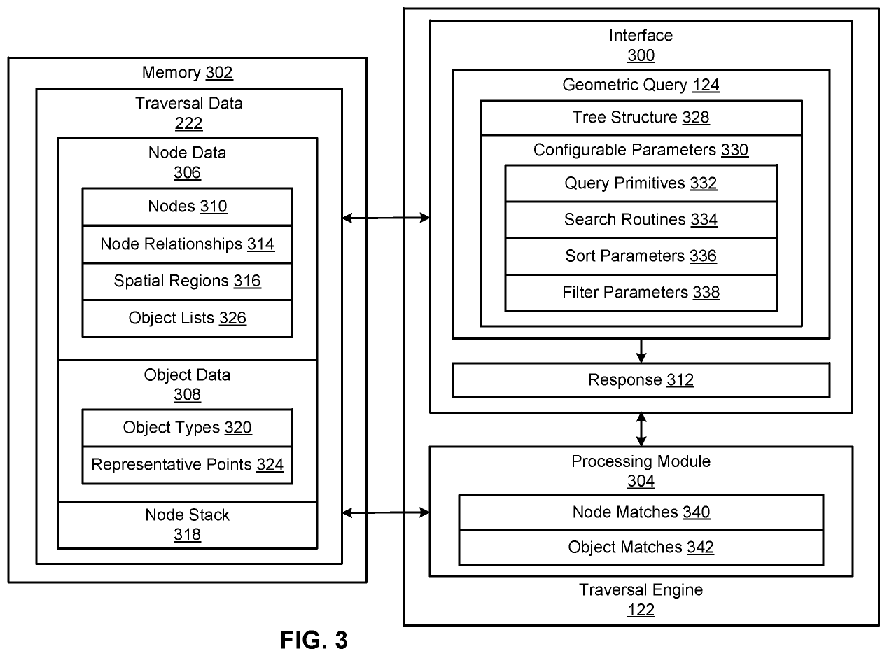

As shown, each GPC 208 has access to a corresponding instance of traversal engine 122, and each DRAM 220 in PP memory 204 stores a partial or complete copy of traversal data 222 that is used by one or more instances of traversal engine 122 to process a corresponding geometric query 124. For example, each GPC 208 could communicate with a separate accelerator implementing traversal engine 122 to traverse a tree structure storing nodes and/or objects during processing of geometric query 124. Traversal engine 122 and traversal data 222 are described in further detail below with respect to FIGS. 3-5.

Those skilled in the art will appreciate that traversal engine 122 and traversal data 222 can be implemented, replicated, or distributed within the systems of FIGS. 1 and 2 multiple ways. First, one or more portions of traversal engine 122 and/or traversal data 222 can be stored in on-chip memory (e.g., static random access memory (SRAM), scratchpad memory, an on-chip cache, etc.) for each GPC 208, in lieu of or in addition to storing traversal engine 122 and/or traversal data 222 on DRAM 220 in PP memory 204. A given GPC 208 or instance of traversal engine 122 can use direct memory access (DMA) to transfer portions of traversal data 222 between DRAM 220 and the on-chip memory. Second, one or more portions of traversal engine 122 and/or traversal data 222 can be stored in an L2 cache in each partition unit 215, in lieu of or in addition to being stored on DRAM 220 in PP memory 204. Third, one instance of traversal engine 122 can be implemented per GPC 208, or one or more instances of traversal engine 122 can be shared by multiple GPCs 208. Fourth, traversal engine 122 can be implemented by one or more GPCs 208, one or more CPUs, and/or by a standalone accelerator that processes requests from one or more GPCs 208.

### Generalized Traversal Framework for Processing

FIG. 3 is a more detailed illustration of traversal engine 122 of FIG. 1, according to various embodiments. As shown in FIG. 3, traversal engine 122 processes a geometric query 124 using traversal data 222 that is stored in memory 302 (e.g., on-chip SRAM, DRAM 220, system memory 104, etc.).

As mentioned above, geometric query 124 specifies a tree structure 328 to be traversed. Tree structure 328 includes a BVH, quad tree, k-d tree, R-tree, rectilinear tree, ball tree, and/or another type of data structure that spatially organizes geometric objects into a hierarchy of nodes. Each node in the hierarchy can represent a particular region of space that encompasses (i.e., bounds) some or all of the geometric objects. The root node in the tree structure represents a single space that encompasses (i.e., bounds) all of the objects, and the child nodes of a given node in the tree structure represent a partitioning of the region of space represented by the node into smaller non-overlapping regions. The leaf nodes in the tree structure represent the smallest regions into which the objects are grouped or organized. Each leaf node additionally stores a set of objects that falls within the corresponding region.

In some embodiments, tree structure 328 is defined and/or traversed using node data 306 related to nodes in tree structure 328 and object data 308 related to geometric objects stored in tree structure 328. Node data 306 includes nodes 310 in tree structure 328, as well as node relationships 314 between pairs of nodes 310 in tree structure 328. For example, each of nodes 310 in a BVH tree structure 328 could include a unique node identifier (ID) for the node, a node type (e.g., non-leaf node, leaf node, etc.), and/or other data associated with the node. The node could also include node relationships 314 that specify offsets to other nodes that are the children of the node and/or the parent of the node.

Node data 306 can also include spatial regions 316 represented by the nodes. For example, spatial regions 316 could include bounding volumes represented by nodes in a BVH and/or partitions that are used to divide the bounding volumes represented by the nodes into smaller bounding volumes represented by child nodes of the node.

Further, node data 306 can include object lists 326 that identify objects assigned to leaf nodes in tree structure 328. For example, each leaf node in tree structure 328 could include offsets to one or more data structures storing objects assigned to that leaf node.

Object data 308 includes object types 320 associated with geometric objects stored in tree structure 328. For example, object types 320 could include mappings of an identifier and/or index for each geometric object to a value that identifies the geometric object as a point, line segment, triangle, box, arbitrarily shaped polygon, circle, curve, polyhedron, cuboid, sphere, ellipsoid, and/or another type of n-dimensional shape.

Object data 308 also includes representative points 324 for geometric objects stored in tree structure 328. For example, representative points 324 could include vertices, centroids, bounding box corners, and/or other points that represent the location, dimensions, boundaries, and/or size of each geometric object.

In some embodiments, traversal engine 122 accesses and/or stores node data 306 and object data 308 from tree structure 328 as a subset of traversal data 222 in memory 302. For example, traversal engine 122 could retrieve a reference and/or pointer to tree structure 328 from geometric query 124 and use the reference and/or pointer to access node data 306 and object data 308 in memory 302. Traversal engine 122 also, or instead, receives some or all of node data 306 and/or object data 308 in geometric query 124 and stores the received node data 306 and/or object data 308 in memory 302.

Geometric query 124 also includes a set of configurable parameters 330 that are used to retrieve a set of geometric objects from tree structure 328. Configurable parameters 330 include data and/or programs that control the way in which geometric query 124 is processed by traversal engine. As shown in FIG. 3, configurable parameters include one or more query primitives 332, one or more search routines 334, one or more sort parameters 336, and/or one or more filter parameters 338.

Query primitives 332 include one or more geometric objects that are tested for spatial relationships with additional geometric objects in tree structure 328 using geometric query 124. For example, query primitives 332 could include one or more points, line segments, rays, boxes, circles, polygons, cuboids, spheres, ellipsoids, polyhedra, and/or other types of n-dimensional shapes. Some or all query primitives 332 could be selected from the set of geometric objects stored in tree structure 328. Some or all query primitives 332 could also, or instead, be specified or defined separately from the set of geometric objects stored in tree structure 328.

Search routines 334 include programmable functions, rules, and/or other user-defined representations of criteria used to test for spatial relationships between query primitives 332 and geometric objects in tree structure 328. For example, search routines 334 could include user-defined criteria for determining whether or not a node and/or geometric object in tree structure 328 is intersected by a ray in query primitives 332, overlaps with one or more query primitives 332, is within a certain distance of one or more query primitives 332, is a k-nearest neighbor of one or more query primitives 332, and/or has another type of spatial relationship with one or more query primitives 332.

Sort parameters 336 include programmable functions, rules, and/or other user-defined representations of criteria used to sort nodes 310 in tree structure 328 while tree structure 328 is traversed during processing of geometric query 124. For example, sort parameters 336 could specify that nodes in tree structure 328 are to be sorted within a node stack 318 based on distances between certain vertices or points in regions represented by the nodes and a “sort origin” point. Sort parameters 336 can be specified and/or defined in a way that increases the efficiency and/or performance with which geometric query 124 is processed. For example, sort parameters 336 could specify an ordering of nodes 310 within node stack 318 that reduces the likelihood of performing computationally expensive matching operations on nodes 310 that are less likely to match query primitives 332, increases the likelihood of early termination of geometric query 124 (e.g., once a valid result or terminating condition is met), balances computational workload across processing units (e.g., CPU cores, GPCs 208, threads, etc.), reduces cache misses, and/or otherwise improves the speed, computational complexity, and/or resource overhead associated with processing geometric query 124.

Filter parameters 338 include programmable functions, rules, and/or other user-defined representations of criteria used to filter nodes 310 and/or geometric objects in tree structure 328 while tree structure 328 is traversed during processing of geometric query 124. For example, filter parameters 338 could specify certain types of geometric objects, orientations of geometric objects, orientations of geometric objects relative to the orientations of one or more query primitives 332, regions within the space represented by tree structure 328, and/or other attributes associated with nodes 310 and/or geometric objects in tree structure 328. Filter parameters 338 could additionally specify that a given attribute is used to omit corresponding nodes 310 and/or geometric objects from further processing and/or inclusion in results of geometric query 124. Filter parameters 338 could also, or instead, specify that a given attribute is required to be present in corresponding nodes 310 and/or geometric objects before these nodes 310 and/or geometric objects are further processed and/or included in results of geometric query 124.

In one or more embodiments, traversal engine 122 includes an interface 300 that receives geometric query 124 from a requesting component or entity. For example, interface 300 could include an application programming interface (API), web-based user interface, graphical user interface (GUI), command line interface (CLI), network interface, serial interface, parallel interface, and/or another type of hardware and/or software interface. The requesting component or entity could transmit geometric query 124 to traversal engine via a call to interface 300, signaling over interface 300, and/or other types of communication supported by interface 300.

For example, interface 300 could include the following representation:

```
Template <typename tree, typename programmableSort, typename
programmableIntersection, typename programmableFilters>
generalizedTraversal (const tree & treeForTraversal,
  const queryPrimitive & queryPrimitives,
  const programmableSort & sortNodes,
  const programmableIntersection & queryPrimitiveTests,
  const programmableFilters & filterParameters)
```

The above representation includes a function named “generalizedTraversal” that can be called to transmit a given geometric query 124 to traversal engine 122. The “generalizedTraversal” function includes parameters named “treeForTraversal,” “queryPrimitives,” “sortNodes,” “queryPrimitive Tests,” and “filterParameters.” The “treeForTraversal” parameter includes a reference to tree structure 328. The “queryPrimitives” parameter references a set of query primitives 332 to be matched to geometric objects in tree structure 328. The “sortNodes” parameter references a set of sort parameters 336 that are used to determine an order in which nodes in tree structure 328 are processed during processing of geometric query 124. The “queryPrimitiveTests” parameter references one or more search routines 334 that can be executed to evaluate criteria for matching one or more query primitives 332 to one or more nodes 310 and/or geometric objects in tree structure 328. The “filterParameters” parameter references a set of filter parameters 338 that can be used to filter nodes 310 and/or geometric objects in tree structure 328 during traversal of tree structure 328.

As mentioned above, query primitives 332 include one or more geometric objects that are matched to additional geometric objects in tree structure 328 using geometric query 124. Continuing with the above example, each query primitive passed to the “generalized Traversal” function could be defined using the following data structure:

```
Template <typename queryPrimitiveDatatype>
{
  size_t numVertices; // 1:point, 2:ray/boxes, >2:polygons
  int vertexDimensionality; // 1:scalar, 2: (x,y) , 3:(x,y,z), ...
  queryPrimitiveDatatype* sortOrigin; // sort origin vertex
  queryPrimitiveDatatype* vertices; // vertex list
} queryPrimitive;
```

The above data structure includes a “numVertices” variable that specifies the number of vertices in the query primitive. The “numVertices” variable can be set to 1 to indicate that the query primitive is a point, to 2 to indicate that the query primitive represents a ray or bounding box, and to a value greater than 2 to indicate that the query primitive represents a polygon. The data structure also includes a “vertexDimensionality” variable that specifies the dimensionality of the query primitive. The data structure additionally includes a “sortOrigin” variable that identifies a point or vertex that is used to sort nodes 310 from tree structure 328. The data structure further includes a “vertices” variable that identifies a list of vertices in the query primitive.

As mentioned above, sort parameters 336 can include user-defined representations of criteria used to sort nodes in tree structure 328 while tree structure 328 is traversed during processing of geometric query 124. An example of a set of sort parameters 336 that can be passed to traversal engine 122 via the example interface 300 above includes the following representation:

```
auto sortNodesExample1 = [&] (const typename Box node1BBox, const
  typename Box node2BBox, const typename Point sortOrigin) {
  return node1BBox.UpperRight.DistTo(sortOrigin) <
    node2BBox.UpperRight.DistTo(sortOrigin);
};
```

More specifically, the example sort parameters 336 above can be used to sort bounding boxes that are named “node1BBox” and “node2BBox” and are represented by two nodes 310 in tree structure 328. These sort parameters 336 specify that the two bounding boxes are to be sorted by the distance between the upper right vertex of each bounding box and a “sortOrigin” point (e.g., the “sortOrigin” from the “queryPrimitive” data structure and/or a different point).

Another example of a set of sort parameters 336 that can be used with the example interface 300 above includes the following representation:

```
auto sortNodesExample2 = [&] (const typename Box node1BBox, const
  typename Box node2BBox, const typename Point sortOrigin) {
  return std::min (std::abs(node1BBox.UpperRight.DistTo(sortOrigin)),
    std::abs(node1BBox.LowerLeft.DistTo(sortOrigin))) <
    std::min(std::abs(node2BBox.UpperRight.DistTo(sortOrigin)),
    std::abs(node2BBox.LowerLeft.DistTo(sortOrigin)));
};
```

These example sort parameters 336 can also be used to sort bounding boxes that are named “node1BBox” and “node2BBox” and are represented by two nodes 310 in tree structure 328. In this example, sort parameters 336 specify that the two bounding boxes are to be sorted by the distance between a “sortOrigin” point and the closer of the upper right vertex or lower left vertex of each bounding box.

As mentioned above, search routines 334 include user-defined representations of criteria used to match nodes 310 and/or query primitives 332 to geometric objects in tree structure 328. An example search routine that can be used with the example interface 300 above includes the following representation:

```
auto queryPrimitiveTestExample = [&] (const typename Box
  anyBBox1, const typename Box anyBBox2) {
  return (std::max(anyBBox1.LowerLeft.x, anyBBox2.LowerLeft.x) <
    std::min(anyBBox1.UpperRight.x, anyBBox2.UpperRight.x));
};
```

This example search routine can be used to determine if two bounding boxes named “anyBBox1” and “anyBBox2” overlap in the x-dimension. If an overlap in the x-dimension is found, the search routine returns true to indicate that a match is found. If no overlap in the x-dimension is found, the search routine returns false to indicate that no match is found.

As mentioned above, filter parameters 338 include user-defined representations of criteria used to filter nodes 310 and/or geometric objects in tree structure 328 while tree structure 328 is traversed during processing of geometric query 124. An example set of filter parameters 338 that can be used with the example interface 300 above includes the following representation:

auto filterParametersExample1 = [&] (const shapePrimitive segment) {
return ((segment.IsHorizontal( ));
};

This example set of filter parameters 338 can be used to identify geometric objects that are horizontal line segments.

Another example set of filter parameters 338 that can be used with the example interface 300 above includes the following representation:

```
auto filterParametersExample2 = [&] (const queryPrimitive ray, const
  shapePrimitive segment) {
  return ray.Direction( ) != segment.Direction( );
};
```

This example set of filter parameters 338 can be used to identify geometric objects that are line segments and that are not parallel to an incoming ray in query primitives 332. In both examples, line segments that meet the conditions set in the corresponding set of filter parameters 338 can be excluded from and/or included in results of geometric query 124.

After geometric query 124 is received over interface 300, a processing module 304 in traversal engine 122 processes geometric query 124 using configurable parameters 330 and traversal data 222. More specifically, processing module 304 uses node stack 318 stored in memory 302 to traverse tree structure 328, starting with the root node of tree structure 328. During the traversal, processing module 304 executes search routines 334 to identify a set of node matches 340 between nodes 310 in node stack 318 and one or more query primitives 332. When search routines 334 determine that a given node in node stack 318 matches one or more query primitives 332, processing module 304 adds child nodes 310 of that node to node stack 318 according to the order specified in sort parameters 336. Processing module 304 also uses filter parameters 338 to filter certain child nodes 310 from node stack 318. Once processing module 304 encounters a leaf node in node stack 318, processing module 304 executes search routines 334 to identify a set of object matches 342 between geometric objects stored in the leaf node and one or more query primitives 332. Processing module 304 adds geometric objects that match the query primitive(s) to results of geometric query 124. Processing module 304 also uses filter parameters 338 to filter certain geometric objects from the results. After node stack is empty 318, processing module 304 returns the set of geometric objects that match query primitives 332 in a response 312 to geometric query 124.

For example, the operation of processing module 304 can be represented by the following pseudocode:

```
Inputs: tree structure, queryPrimitive, sortNodes,
  queryPrimitiveTests, filterParameters
populate node stack with root node from tree structure
while node stack not empty do
  pop node from node stack
  call queryPrimitiveTests between node & query primitive
  if match found:
    if not leaf:
      foreach child of node:
        call filterParameters to check if child should be
          filtered
        if child not filtered:
          call sortNodes to identify the ordered location of
            the child in node stack
          add child to stack in the ordered location
    else:
      foreach object in node:
        call filterParameters to check if object should be
          filtered
        call queryPrimitiveTests between object & query
          primitive
        if (object not filtered && match found):
          add the query primitive to result
return result
```

In the above pseudocode, input into processing module 304 includes tree structure 328, a “queryPrimitive” data structure that stores one or more query primitives 332, a set of sort parameters 336 specified in a “sortNodes” function, a set of search routines specified in a “queryPrimitiveTests” function, and a set of filter parameters 338 specified in a “filterParameters” function. As discussed above, this input can be specified in geometric query 124 that is received over interface 300. Given this input, the pseudocode begins by adding the root node from tree structure 328 to node stack 318. The pseudocode then processes nodes 310 in node stack 318 by popping the nodes from the top of node stack 318.

Continuing with the discussion of the above pseudocode, each node that is popped from node stack 318 is evaluated using search routines 334 to determine if the node matches one or more query primitives 332. If the node matches one or more query primitives 332 and is not a leaf node, each child node of the node is evaluated using filter parameters 338. If a given child node is not filtered using filter parameters 338, sort parameters 336 are used to determine the position of the child node in node stack 318, and the child node is added to node stack 318 in that position. If a given child node is filtered using filter parameters 338, that child node is not added to node stack 318.

When a leaf node is popped from node stack 318, each geometric object stored in the leaf node is evaluated using search routines 334 to determine if the geometric object matches one or more query primitives 332. Each geometric object is also evaluated using filter parameters 338 to determine if the geometric object should be filtered from a result of geometric query 124. If a geometric object matches one or more query primitives 332 and is not filtered using filter parameters 338, the geometric object is added to the result. Otherwise, the geometric object is not added to the result.

The pseudocode repeats the process with remaining nodes in node stack 318 until node stack 318 is empty. After node stack 318 is emptied, the pseudocode returns the result of geometric query 124 in response 312. This result includes a list or set of geometric objects from tree structure 328 that are matched to query primitives 332 using search routines 334 and are not filtered using filter parameters 338.

In one or more embodiments, processing module 304 processes geometric query 124 using a single traversal of tree structure 328. Unlike conventional approaches that perform a first traversal to determine memory requirements associated with a geometric query and a second traversal to store matching shapes in the memory allocated after the first traversal, this single-traversal approach uses a pre-allocated memory pool to concurrently store matching geometric objects from all GPU cores or processing units executing geometric query 124. The single-traversal approach also includes a postprocessing step to group and sort the matching geometric objects by user-defined regions of interest specified in configurable parameters 330. Consequently, the single traversal of tree structure 328 enabled by the pre-allocated memory pool can be faster and more computationally efficient than the conventional two-traversal scheme.

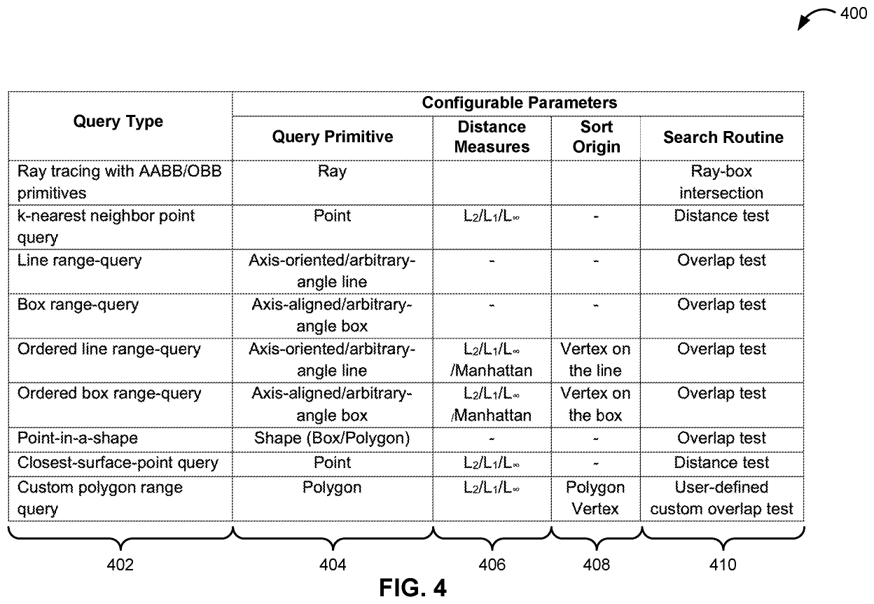

FIG. 4 illustrates an exemplar table 400 of configurable parameters 330 for geometric queries that can be processed by traversal engine 122 of FIG. 1, according to various embodiments. As shown in FIG. 4, table 400 includes a first column 402 that includes different types of geometric queries that can be processed by traversal engine 122 and a second column 404 that includes query primitives 332 associated with each type of geometric query. Table 400 also includes a third column 406 that includes distance measures that can be used to sort nodes in tree structure 328 during processing of the corresponding geometric queries. The distance measures in column 406 can also, or instead, be used to evaluate distance-based criteria for matching nodes and/or geometric objects in tree structure 328 to query primitives 332.

Table 400 further includes a fourth column 408 that includes different types of sort origins that can be used to sort nodes in tree structure 328 during processing of the corresponding geometric queries. Table 400 additionally includes a fifth column 410 that includes different types of tests that can be performed by search routines 334 in matching query primitives 332 in the corresponding types of geometric queries to geometric objects in tree structure 328.

As mentioned above, configurable parameters 330 can be specified for each type of geometric query 124 and/or each individual geometric query 124 processed by traversal engine 122. For example, configurable parameters 330 could include user-defined functions, rules, and/or values that are specified for each geometric query 124 and passed to traversal engine 122 via interface 300, as described above. In another example, at least some configurable parameters 330 (e.g., types of query primitives 332, distance measures, sort parameters 336, search routines 334, filter parameters 338, etc.) could be predefined for a given type of geometric query 124, and interface 300 could include a specific function for performing that type of geometric query 124. When the function is called, a specific tree structure 328 and any remaining configurable parameters 330 (e.g., vertices and/or other values that define query primitives 332 to be matched to geometric objects stored in tree structure 328) associated with that type of geometric query 124 could be passed to traversal engine 122 to allow traversal engine 122 to generate a corresponding response.

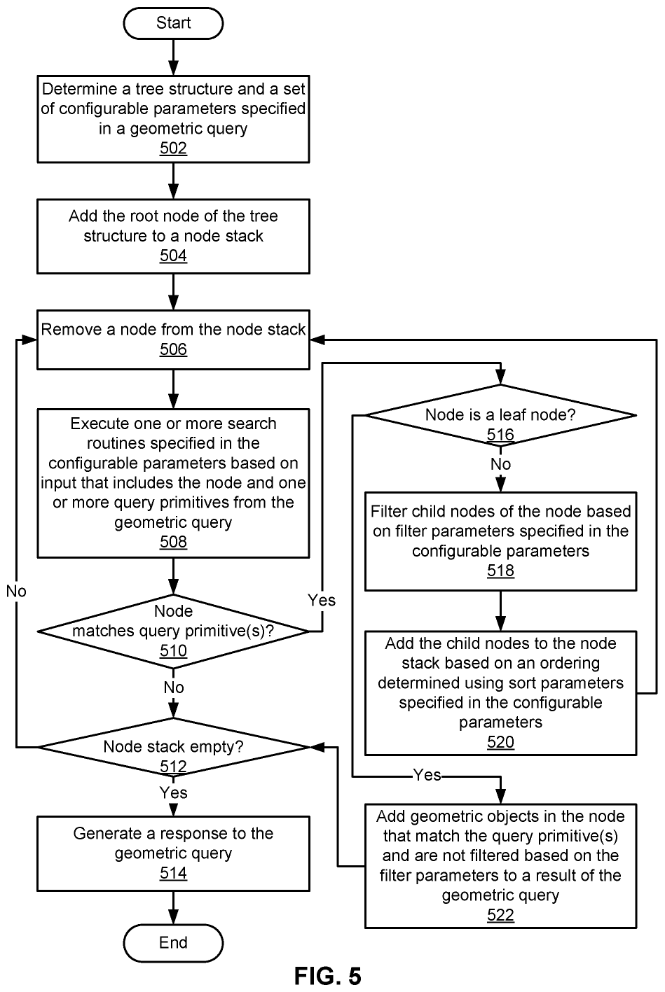

FIG. 5 sets forth a flow diagram of method steps for processing a geometric query, according to various embodiments. Although the method steps are described in conjunction with the systems of FIGS. 1-3, persons skilled in the art will understand that any system configured to perform the method steps in any order falls within the scope of the present disclosure.

As shown, in step 502, traversal engine 122 determines a tree structure and a set of configurable parameters specified in a geometric query. For example, traversal engine 122 could receive the geometric query over an interface. The geometric query could include values of, references to, and/or other representations of the tree structure and configurable parameters.

Next, traversal engine 122 traverses the tree structure and executes one or more search routines in the configurable parameters to process the geometric query. More specifically, in step 504, traversal engine 122 adds the root node of the tree structure to a node stack. For example, traversal engine 122 could initialize an empty node stack and push the root node onto the node stack.

In step 506, traversal engine 122 removes a node from the node stack. Continuing with the above example, traversal engine 122 could pop the topmost node from the node stack.

In step 508, traversal engine 122 executes one or more search routines specified in the configurable parameters based on input that includes the node and one or more query primitives from the geometric query. For example, traversal engine 122 could call each search routine and pass the node and query primitive(s) as arguments in the call. Each search routine could perform an intersection test, distance test, overlap test, and/or another type of spatial relationship test between the node and query primitive(s).

In step 510, traversal engine 122 determines whether or not the node matches the query primitive(s). For example, traversal engine 122 could receive, from each search routine executed in step 508, binary values and/or other indications of a match or lack of match between the node and the query primitive(s).

If traversal engine 122 determines that the node does not match the query primitive(s) in step 510, traversal engine 122 performs step 512 to determine whether or not the node stack is empty. If the node stack is not empty, traversal engine 122 returns to step 506 to process remaining nodes in the node stack. If the node stack is empty, traversal engine 122 performs step 514 to finish processing of the query. In step 514, traversal engine 122 generates a response to the geometric query. When traversal engine 122 performs step 514 after determining that the root node does not match any query primitives, the response can include an empty set of geometric objects.

If traversal engine 122 determines in step 510 that the node removed from the node stack matches the query primitive(s), traversal engine 122 performs step 516 to determine whether or not the node is a leaf node. If traversal engine 122 determines in step 516 that the node is not a leaf node, traversal engine 122 performs step 518 to filter child nodes of the node based on filter parameters specified in the configurable parameters. For example, traversal engine 122 could filter the child nodes based on attributes of the regions represented by the child nodes, the distances between the regions represented by the child nodes and one or more points in a query primitive, and/or other criteria. Traversal engine 122 also performs step 520 to add the child nodes that pass the filters to the node stack based on an ordering determined using sort parameters specified in the configurable parameters. For example, traversal engine 122 could sort the child nodes based on a distance measure, sort origin, and/or other criteria included in the sort parameters. Traversal engine 122 then returns to step 506 to process remaining nodes in the node stack.

If traversal engine 122 determines in step 516 that the node is a leaf node, traversal engine 122 performs step 522 to add geometric objects in the node that match the query primitive(s) and are not filtered based on the filter parameters to a result of the geometric query. For example, traversal engine 122 could apply the search routines and filter parameters to each geometric object stored in the node. If the search routines and filter parameters indicate that a given geometric object matches the query primitive(s) and is not filtered, traversal engine 122 could add the geometric object to a list of geometric objects to be returned in the response to the query. Traversal engine 122 could also add the geometric object to a position in the list based on additional sort parameters in the configurable parameters. If the search routines and filter parameters indicate that a given geometric object does not match the query primitive(s) and/or is filtered, traversal engine 122 could omit the geometric object from the list of geometric objects to be returned in the response to the query.

After step 522 is complete, traversal engine 122 returns to step 512 to determine whether or not the node stack is empty. Once traversal engine 122 determines in step 512 that the node stack is empty, traversal engine 122 performs step 514 to return any geometric objects that match the query primitive(s) and are not filtered in a response to the query.

In sum, the disclosed techniques the disclosed techniques provide a generalized traversal framework for processing geometric queries. The generalized traversal framework receives a given geometric query that specifies a hierarchical data structure to traverse, such as a bounding volume hierarchy (BVH) and/or another type of tree structure. The geometric query also includes a set of configurable parameters that control the traversal of the tree structure and/or processing of the geometric query. The configurable parameters also include (but are not limited to) data structures representing query primitives such as points, rays, line segments, boxes, and/or polygons; search routines that define or implement search criteria for matching the query primitives to geometric objects stored in the tree structure; sorting parameters used to sort shapes or regions that match the geometric query; and/or filter parameters used in filtering the shapes or regions during traversal of the hierarchical data structure.

The generalized traversal framework processes the geometric query by traversing the hierarchical data structure. During the traversal, the generalized traversal framework uses the search routines to determine whether or not a given node in the hierarchical data structure represents a region that intersects, overlaps with, is within a certain distance of, and/or otherwise meets the search criteria associated with one or more query primitives in the geometric query. The generalized traversal framework repeats the process with child nodes of any node that meets the search criteria. The generalized traversal framework also uses the filter parameters in the geometric query to filter nodes and/or the corresponding subtrees during the traversal. Once the traversal reaches a leaf node that meets the search criteria, the generalized traversal framework iteratives over geometric objects stored in the leaf node and determines whether each geometric object meets the search criteria and/or passes any filters specified in the filter parameters. The generalized traversal framework then returns a set of geometric objects that both meet the search criteria and pass the filters in a response to the geometric query.

One technical advantage of the disclosed techniques relative to the prior art is that, with the disclosed techniques, geometric queries involving traversal of hierarchical data structures can be defined and executed in a flexible, configurable manner. Accordingly, the disclosed techniques can be used to create and process geometric queries more quickly and efficiently than conventional approaches that involve programming and executing separate workflows for different types of geometric queries. Another technical advantage of the disclosed techniques is the ability to filter certain nodes and/or geometric objects in a hierarchical data structure before performing computationally-intensive matching operations using the nodes and/or geometric objects. Consequently, the disclosed techniques can be used to process geometric queries with less latency and resource overhead than prior art approaches. These technical advantages provide one or more technological improvements over prior art approaches.

1. In some embodiments, a computer-implemented method for processing a geometric query comprises determining a tree structure and a set of configurable parameters specified in the geometric query, wherein the set of configurable parameters comprises one or more query primitives and one or more search routines; performing one or more operations that traverse the tree structure and execute the one or more search routines to match the one or more query primitives to a first set of geometric objects included in the tree structure; and generating a response to the geometric query, wherein the response includes the first set of geometric objects.

2. The computer-implemented method of clause 1, wherein the one or more query primitives are matched to the first set of geometric objects by inputting a first query primitive included in the one or more query primitives and a first node included in the tree structure into a first search routine included in the one or more search routines; executing the first search routine to determine that the first node meets one or more search criteria associated with the geometric query; and retrieving the first set of geometric objects from one or more nodes that are descendants of the first node within the tree structure.

3. The computer-implemented method of any of clauses 1-2, wherein retrieving the first set of geometric objects from the one or more nodes comprises traversing, within the tree structure, one or more paths from the first node to the one or more nodes; and for each node included in the one or more paths, executing the first search routine to determine that the node meets the one or more search criteria associated with the geometric query.

4. The computer-implemented method of any of clauses 1-3, wherein the one or more search criteria comprise at least one of an intersection test, a distance test, or an overlap test.

5. The computer-implemented method of any of clauses 1-4, wherein the one or more query primitives are matched to the first set of geometric objects by retrieving a second set of geometric objects from one or more leaf nodes that are included in the tree structure and that match the one or more query primitives; and filtering the second set of geometric objects based on one or more filter parameters included in the set of configurable parameters to determine the first set of geometric objects.

6. The computer-implemented method of any of clauses 1-5, wherein the one or more filter parameters comprise at least one of an orientation of a geometric object, an orientation of the one or more query primitives, or a type of geometric object.

7. The computer-implemented method of any of clauses 1-6, wherein the tree structure is traversed by determining an ordering of a set of nodes included in the tree structure based on one or more sort parameters included in the set of configurable parameters; and evaluating the set of nodes based on the ordering.

8. The computer-implemented method of any of clauses 1-7, wherein the tree structure is traversed by further filtering one or more nodes from the ordering based on one or more filter parameters included in the set of configurable parameters.

9. The computer-implemented method of any of clauses 1-8, wherein the one or more sort parameters comprise at least one of a sort origin or a distance measure.

10. The computer-implemented method of any of clauses 1-9, wherein the geometric query comprises at least one of a ray tracing query, an intersection query, a nearest neighbor query, or a range query.

11. In some embodiments, one or more non-transitory computer-readable media store instructions that, when executed by one or more processors, cause the one or more processors to perform the steps of determining a tree structure and a set of configurable parameters specified in a geometric query, wherein the set of configurable parameters comprises one or more query primitives and one or more search routines; performing one or more operations that traverse the tree structure and execute the one or more search routines to match the one or more query primitives to a first set of geometric objects included in the tree structure; and generating a response to the geometric query, wherein the response includes the first set of geometric objects.

12. The one or more non-transitory computer-readable media of clause 11, wherein the one or more query primitives are matched to the first set of geometric objects by inputting a first query primitive included in the one or more query primitives and a first node included in the tree structure into a first search routine included in the one or more search routines; executing the first search routine to determine that the first node meets one or more search criteria associated with the geometric query; and adding a set of nodes that are children of the first node to a node stack.

13. The one or more non-transitory computer-readable media of any of clauses 11-12, wherein the one or more query primitives are matched to the first set of geometric objects by further filtering the set of nodes based on one or more filter parameters included in the set of configurable parameters prior to adding the set of nodes to the node stack.

14. The one or more non-transitory computer-readable media of any of clauses 11-13, wherein adding the set of nodes to the node stack comprises determining an ordering of the set of nodes within the node stack based on one or more sort parameters included in the set of configurable parameters.

15. The one or more non-transitory computer-readable media of any of clauses 11-14, wherein the one or more query primitives are further matched to the first set of geometric objects by determining that a second node included in the set of nodes corresponds to a leaf node within the tree structure; retrieving a second set of geometric objects from the second node; and adding one or more geometric objects that are included in the second set of geometric objects and that match the one or more query primitives to the first set of geometric objects.

16. The one or more non-transitory computer-readable media of any of clauses 11-15, wherein the instructions further cause the one or more processors to perform the step of filtering the first set of geometric objects based on one or more filter parameters included in the set of configurable parameters prior to generating the response to the geometric query.

17. The one or more non-transitory computer-readable media of any of clauses 11-16, wherein determining the set of configurable parameters comprises receiving the set of configurable parameters with the geometric query over an interface.

18. The one or more non-transitory computer-readable media of any of clauses 11-17, wherein the tree structure comprises at least one of a bounding volume hierarchy, a quad tree, a k-d tree, an R-tree, a ball tree, or a rectilinear tree.

19. The one or more non-transitory computer-readable media of any of clauses 11-18, wherein the one or more query primitives comprise at least one of a point, a line segment, a ray, a box, or a polygon.

20. In some embodiments, a system comprises one or more memories that store instructions, and a plurality of processing units that are coupled to the one or more memories and, when executing the instructions, are configured to perform the steps of determining a tree structure and a set of configurable parameters specified in a geometric query, wherein the set of configurable parameters comprises one or more query primitives and one or more search routines; performing one or more operations that traverse the tree structure and execute the one or more search routines to match the one or more query primitives to a first set of geometric objects included in the tree structure; storing the first set of geometric objects in a pre-allocated memory pool associated with the plurality of processing units; and generating a response to the geometric query, wherein the response includes the first set of geometric objects.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for processing a geometric query, the method comprising:
determining a tree structure and a set of configurable parameters specified in the geometric query, wherein the set of configurable parameters comprises one or more query primitives and one or more search routines;
performing one or more operations that traverse the tree structure and execute the one or more search routines to match the one or more query primitives to a first set of geometric objects included in the tree structure; and
generating a response to the geometric query, wherein the response includes the first set of geometric objects.

2. The computer-implemented method of claim 1, wherein the one or more query primitives are matched to the first set of geometric objects by:
inputting a first query primitive included in the one or more query primitives and a first node included in the tree structure into a first search routine included in the one or more search routines;
executing the first search routine to determine that the first node meets one or more search criteria associated with the geometric query; and
retrieving the first set of geometric objects from one or more nodes that are descendants of the first node within the tree structure.

3. The computer-implemented method of claim 2, wherein retrieving the first set of geometric objects from the one or more nodes comprises:
traversing, within the tree structure, one or more paths from the first node to the one or more nodes; and
for each node included in the one or more paths, executing the first search routine to determine that the node meets the one or more search criteria associated with the geometric query.

4. The computer-implemented method of claim 2, wherein the one or more search criteria comprise at least one of an intersection test, a distance test, or an overlap test.

5. The computer-implemented method of claim 1, wherein the one or more query primitives are matched to the first set of geometric objects by:
retrieving a second set of geometric objects from one or more leaf nodes that are included in the tree structure and that match the one or more query primitives; and
filtering the second set of geometric objects based on one or more filter parameters included in the set of configurable parameters to determine the first set of geometric objects.

6. The computer-implemented method of claim 5, wherein the one or more filter parameters comprise at least one of an orientation of a geometric object, an orientation of the one or more query primitives, or a type of geometric object.

7. The computer-implemented method of claim 1, wherein the tree structure is traversed by:
determining an ordering of a set of nodes included in the tree structure based on one or more sort parameters included in the set of configurable parameters; and
evaluating the set of nodes based on the ordering.

8. The computer-implemented method of claim 7, wherein the tree structure is traversed by further filtering one or more nodes from the ordering based on one or more filter parameters included in the set of configurable parameters.

9. The computer-implemented method of claim 7, wherein the one or more sort parameters comprise at least one of a sort origin or a distance measure.

10. The computer-implemented method of claim 1, wherein the geometric query comprises at least one of a ray tracing query, an intersection query, a nearest neighbor query, or a range query.

11. One or more non-transitory computer-readable media storing instructions that, when executed by one or more processors, cause the one or more processors to perform the steps of:
determining a tree structure and a set of configurable parameters specified in a geometric query, wherein the set of configurable parameters comprises one or more query primitives and one or more search routines;
performing one or more operations that traverse the tree structure and execute the one or more search routines to match the one or more query primitives to a first set of geometric objects included in the tree structure; and
generating a response to the geometric query, wherein the response includes the first set of geometric objects.

12. The one or more non-transitory computer-readable media of claim 11, wherein the one or more query primitives are matched to the first set of geometric objects by:
inputting a first query primitive included in the one or more query primitives and a first node included in the tree structure into a first search routine included in the one or more search routines;
executing the first search routine to determine that the first node meets one or more search criteria associated with the geometric query; and
adding a set of nodes that are children of the first node to a node stack.

13. The one or more non-transitory computer-readable media of claim 12, wherein the one or more query primitives are matched to the first set of geometric objects by further filtering the set of nodes based on one or more filter parameters included in the set of configurable parameters prior to adding the set of nodes to the node stack.

14. The one or more non-transitory computer-readable media of claim 12, wherein adding the set of nodes to the node stack comprises determining an ordering of the set of nodes within the node stack based on one or more sort parameters included in the set of configurable parameters.

15. The one or more non-transitory computer-readable media of claim 12, wherein the one or more query primitives are further matched to the first set of geometric objects by:
determining that a second node included in the set of nodes corresponds to a leaf node within the tree structure;
retrieving a second set of geometric objects from the second node; and
adding one or more geometric objects that are included in the second set of geometric objects and that match the one or more query primitives to the first set of geometric objects.

16. The one or more non-transitory computer-readable media of claim 11, wherein the instructions further cause the one or more processors to perform the step of filtering the first set of geometric objects based on one or more filter parameters included in the set of configurable parameters prior to generating the response to the geometric query.

17. The one or more non-transitory computer-readable media of claim 11, wherein determining the set of configurable parameters comprises receiving the set of configurable parameters with the geometric query over an interface.

18. The one or more non-transitory computer-readable media of claim 11, wherein the tree structure comprises at least one of a bounding volume hierarchy, a quad tree, a k-d tree, an R-tree, a ball tree, or a rectilinear tree.

19. The one or more non-transitory computer-readable media of claim 11, wherein the one or more query primitives comprise at least one of a point, a line segment, a ray, a box, or a polygon.

20. A system, comprising:
one or more memories that store instructions, and
a plurality of processing units that are coupled to the one or more memories and, when executing the instructions, are configured to perform the steps of:
determining a tree structure and a set of configurable parameters specified in a geometric query, wherein the set of configurable parameters comprises one or more query primitives and one or more search routines;
performing one or more operations that traverse the tree structure and execute the one or more search routines to match the one or more query primitives to a first set of geometric objects included in the tree structure;
storing the first set of geometric objects in a pre-allocated memory pool associated with the plurality of processing units; and
generating a response to the geometric query, wherein the response includes the first set of geometric objects.
